(19) United States
(12) Patent Application Publication
(10) Pub. No.: US 2008/0263117 A1
(43) Pub. Date: Oct. 23, 2008

(54) INITIAL SEED MANAGEMENT FOR PSEUDORANDOM NUMBER GENERATOR

(76) Inventors: Gregory Gordon Rose, San Diego, CA (US); Alexander Gantman, Poway, CA (US); Lu Xiao, San Diego, CA (US); David Figueroa, Carlsbad, CA (US)

Correspondence Address: QUALCOMM INCORPORATED, 5775 MOREHOUSE DR., SAN DIEGO, CA, 92121, US

(21) Appl. No.: 11/738,972

(22) Filed: Apr. 23, 2007

(51) Int. Cl. G06F 7/58; G06F 15/177

(52) U.S. Cl. 708/254; 713/1

(57) ABSTRACT

A secure seeding and reseeding scheme is provided for pseudorandom number generators by using a pre-stored initialization seed. This scheme initializes a pseudorandom number generator into an unknown state even when entropy collection is unavailable. A primary seed file and a shadow seed file are maintained with initialization seed information in a secure file system. If the primary seed file is corrupted, the pseudorandom number generator is seeded with the content of the shadow seed file. Additionally, a trusted timer or clock may be mixed with the pre-stored initialization seed to add entropy even when the pre-stored seed information has been compromised.

### FIELD

The present invention relates to secure pseudorandom number generators and more particularly to seed management for initializing a pseudo-random number generator in electronic devices.

### BACKGROUND

Generation of random numbers has many applications, including cryptographic uses (e.g., keys used for encryption and integrity protection, nonces used for security protocols, etc.) for example. A true random number is impossible to be predicted with probability higher than average. In the real world, it is extremely hard to obtain a perfect random number source.

A pseudo-random number generator (PRNG) is often employed that uses a deterministic algorithm to generate pseudo-random numbers. The PRNG can produce numbers at a very fast speed. Given a random input called a seed, a very long sequence of pseudo-random numbers can be generated deterministically. Without knowledge of this seed, it is infeasible or very hard to distinguish the generator from a random source. While there are many PRNGs available, most are not designed for security applications. Because PRNGs use deterministic algorithms, they are exposed to hacking, thereby weakening the security of the PRNG. For example, a linear congruential generator is widely used as a PRNG but can be broken after a short sequence of output is analyzed.

Some applications, such as cryptographic applications, typically use “random” numbers as initialization vectors, keys, nonces, salts, etc. Generally, a cryptographically secure PRNG (CSPRNG) is seeded with unpredictable inputs in a secure way so that it is infeasible to distinguish its output from a sequence of random bits.

A pseudo-random number generation scheme is relatively straightforward in a CSPRNG. It can be, for example, a block cipher running in counter mode or output feedback mode, a stream cipher using a seed as cipher key, or a nested structure of hashing. A complicated part in CSPRNG design is how to seed and reseed the CSPRNG. Ideally, the CSPRNG is seeded with some information that makes the internal state of the generator unpredictable before it is called by an application. Reseeding is a process used to update the sequential logic of a CSPRNG, which has been previously seeded, with a new seed. Such reseeding makes it more difficult to break a deterministic number generation algorithm. However, it costs time for an entropy collection module to get a good seed. Thus, seeding or reseeding a CSPRNG before it is called by an application is a common problem since, upon power up, the CSPRNG may be called by an application before such a seed is available.

There exist a number of standardized CSPRNG designs, such as FIPS 186-2, ANSI X9.17-1985 Appendix C, ANSI X9.31-1998 Appendix A.2.4, and ANSI X9.62-1998 Annex A.4. Unfortunately, many of these designs are not satisfactory under certain circumstances. For example, two design flaws of ANSI X9.17 PRNG have been identified by J. Kelsey et al. at Fast Software Encryption, 5th International Workshop Proceedings, Springer-Verlag, 1998. Additionally, National Institute of Standards and Technology (NIST) Special Publication 800-90, titled “Recommendation for Random Number Generator Using Deterministic Random Bit Generators”, June 2006, also discloses a system for initializing a pseudorandom number generator but fails to provide adequate security features against hacking.

Therefore, there is a need for a pseudo-random number generator where a seed can be quickly and securely obtained.

### SUMMARY

A secure seeding and reseeding scheme is provided for pseudorandom number generators by using a pre-stored initialization seed. This scheme initializes a pseudorandom number generator into an unknown state even when entropy collection is unavailable. A primary seed file and a shadow seed file may be maintained with seeding information in a secure file system. If the primary seed file is corrupted, the pseudorandom number generator is seeded with the content of the shadow seed file. A trusted timer may be used as part of the seeding mechanism as a countermeasure to hacking of the seed files. A trusted timer or clock is mixed with pre-stored seed information to add entropy even when the pre-stored seed information has been compromised.

A method for operating a pseudorandom number generator is provided. A startup internal state of the pseudorandom number generator is initialized with a pre-stored primordial seed. The stored primordial seed may be destroyed after it has been used once. A new seed may be obtained from one or more unpredictable sources of entropy and the new seed may be used to modifying the internal state of the pseudorandom number generator into an unpredictable state. A pseudorandom output may be generated based on the modified internal state of the pseudorandom number generator. The pseudorandom output may then be stored in a seed file as an initialization seed for a subsequent startup internal state of the pseudorandom number generator. The primordial seed may be stored in a secure location during manufacturing of the pseudorandom number generator. Reseeding of the pseudorandom number generator may be periodically performed according to an interval timer.

In one example, the initialization seed may be retrieved from the seed file after the pseudorandom number generator is restarted. The startup internal state of the pseudorandom number generator may be initialized with the initialization seed. The content of the seed file may be replaced with a new initialization seed obtained from the pseudorandom number generator.

In another example, a time value is then obtained from a trusted source. The time value and initialization seed are then combined to obtain a modified initialization seed. The time value and initialization seed may be combined such that the time value is dissipated into the whole range of the modified initialization seed. A startup internal state of the pseudorandom number generator may be initialized with the modified initialization seed. The content of the seed file may then be replaced with a new initialization seed obtained from pseudorandom output of the pseudorandom number generator.

In yet another aspect, storing the pseudorandom output in a seed file may include (1) storing the pseudorandom output in a primary seed file in a secure file system and (2) storing the pseudorandom output in a shadow seed file in the secure file system. Upon restarting the pseudorandom number generator, a determination is made as to whether the integrity of the primary seed file has been compromised. If the integrity of the primary file is successfully verified, the startup internal state of the pseudorandom number generator is initialized with the initialization seed of the primary seed file. Otherwise, if the integrity check of the primary seed file fails, the startup internal state of the pseudorandom number generator is initialized with the initialization seed of the shadow seed file.

A pseudorandom number generator is also provided comprising a seed selection module, a seeding module, and a number generation module. The seed selection module may be configured to select a seed from one or more seed sources. The seeding module is coupled to the seed selection module and may be configured to adjust an internal state of the pseudorandom number generator according to a seed provided by the seed selection module. The number generation module is coupled to the seeding module and may be configured to generate a pseudorandom output based on the internal state of the pseudorandom number generator. The seed selection module may be further configured to (a) select a pre-stored primordial seed to initialize a startup internal state of the pseudorandom number generator if it is the first time the pseudorandom number generator is started, and/or (b) select an initialization seed from a pre-stored seed file to initialize the startup internal state the pseudorandom number generator if the pseudorandom number generator has been previously started. The seed selection module may destroy the stored primordial seed after it has been used once. The number generation module may provide a pseudorandom output that is stored in the seed file and used as the initialization seed.

According to one feature, the pseudorandom number generator may further include a trusted time source coupled to the seeding module. The seeding module may be further configured to (a) obtain a time value from the trusted time source; (b) combine the time value and initialization seed to obtain a modified initialization seed; and (c) initialize a startup internal state of the pseudorandom number generator with the modified initialization seed. The time value and initialization seed may be combined such that the time value is dissipated into the whole range of the modified initialization seed.

According to another feature, the pseudorandom number generator may further include a secure file system for storing the seed file. The seed file may include a primary seed file and a shadow seed file. The seed selection module may be further configured to (a) determine whether the integrity of the primary seed file has been compromised upon restarting the pseudorandom number generator; (b) initialize the startup internal state of the pseudorandom number generator with the initialization seed of the primary seed file if the integrity of the primary file is successfully verified; and/or (c) initialize the startup internal state of the pseudorandom number generator with the initialization seed of the shadow seed file otherwise.

Consequently, a pseudorandom number generator is also provided, comprising: (a) means for initializing a startup internal state of the pseudorandom number generator with a pre-stored primordial seed; (b) means for destroying the stored primordial seed after it has been used once; (c) means for obtaining a new seed from one or more unpredictable sources of entropy; (d) means for modifying the internal state of the pseudorandom number generator into an unpredictable state with the new seed; (e) means for generating a pseudorandom output based on the modified internal state of the pseudorandom number generator; (f) means for storing the pseudorandom output in a seed file as an initialization seed for a subsequent startup internal state of the pseudorandom number generator; (g) means for storing the primordial seed in a secure location during manufacturing of the pseudorandom number generator; (h) means for retrieving the initialization seed from the seed file after the pseudorandom number generator is restarted; (i) means for initializing the startup internal state of the pseudorandom number generator with the initialization seed; and/or 0) means for replacing the content of the seed file with a new initialization seed obtained from the pseudorandom number generator.

In one example, the pseudorandom number generator may further comprise: (a) means for retrieving the initialization seed from the seed file after the pseudorandom number generator is restarted; (b) means for obtaining a time value from a trusted source; (c) means for combining the time value and initialization seed to obtain a modified initialization seed; (d) means for initializing a startup internal state of the pseudorandom number generator with the modified initialization seed; and/or (e) means for replacing the content of the seed file with a new initialization seed obtained from pseudorandom output of the pseudorandom number generator. The time value and initialization seed may be combined such that the time value is dissipated into the whole range of the modified initialization seed.

In another example, the pseudorandom number generator may also comprise: (a) means for storing the pseudorandom output in a primary seed file in a secure file system; (b) means for storing the pseudorandom output in a shadow seed file in the secure file system; (c) means for determining whether the integrity of the primary seed file has been compromised upon restarting the pseudorandom number generator; (d) means for initializing the startup internal state of the pseudorandom number generator with the initialization seed of the primary seed file if the integrity of the primary file is successfully verified; and/or (e) means for initializing the startup internal state of the pseudorandom number generator with the initialization seed of the shadow seed file otherwise.

A processing circuit is also provided comprising a memory device and a processing device. The memory device may include one or more internal state registers to store the internal state of a pseudorandom number generator. The processing device is coupled to the memory device and may be configured to (a) initialize a startup internal state of the pseudorandom number generator with a pre-stored primordial seed; (b) destroy the stored primordial seed after it has been used once; (c) obtain a new seed from one or more unpredictable sources of entropy; (d) reseed the pseudorandom number generator with the new seed to modify the internal state of the pseudorandom number generator into an unpredictable state; (e) generate a pseudorandom output based on the modified internal state of the pseudorandom number generator; and/or (f) store the pseudorandom output in a seed file as an initialization seed for a subsequent startup internal state of the pseudorandom number generator.

According to one feature, the processing device may be further configured to (a) retrieve the initialization seed from the seed file after the pseudorandom number generator is restarted; (b) obtain a time value from a trusted source; (c) combine the time value and initialization seed to obtain a modified initialization seed; (d) initialize a startup internal state of the pseudorandom number generator with the modified initialization seed; and/or (e) replace the content of the seed file with a new initialization seed obtained from pseudorandom output of the pseudorandom number generator. The time value and initialization seed may be combined such that the time value is dissipated into the whole range of the modified initialization seed.

According to one feature, the processing device may be further configured to (a) store the pseudorandom output in a primary seed file in a secure file system; (b) store the pseudorandom output in a shadow seed file in the secure file system; (c) determine whether the integrity of the primary seed file has been compromised upon restarting the pseudorandom number generator; (d) initialize the startup internal state of the pseudorandom number generator with the initialization seed of the primary seed file if the integrity of the primary file is successfully verified; and/or (e) initialize the startup internal state of the pseudorandom number generator with the initialization seed of the shadow seed file otherwise.

A machine-readable medium is also provided having one or more instructions for generating pseudorandom output, which when executed by a processor causes the processor to: (a) initialize a startup internal state of the pseudorandom number generator with a pre-stored primordial seed; (b) destroy the stored primordial seed after it has been used once; (c) obtain a new seed from one or more unpredictable sources of entropy; (d) reseed the pseudorandom number generator with the new seed to modify the internal state of the pseudorandom number generator into an unpredictable state; (e) generate a pseudorandom output based on the modified internal state of the pseudorandom number generator; and/or (f) store the pseudorandom output in a seed file as an initialization seed for a subsequent startup internal state of the pseudorandom number generator.

In one example, the machine-readable medium may further have one or more instructions which when executed by a processor causes the processor to: (a) retrieve the initialization seed from the seed file after the pseudorandom number generator is restarted; (b) obtain a time value from a trusted source; (c) combine the time value and initialization seed to obtain a modified initialization seed; (d) initialize a startup internal state of the pseudorandom number generator with the modified initialization seed; and/or (e) replace the content of the seed file with a new initialization seed obtained from pseudorandom output of the pseudorandom number generator. The time value and initialization seed are combined such that the time value is dissipated into the whole range of the modified initialization seed.

According to one feature, the seed file may include a primary seed file and a shadow seed file in a secure file system. The machine-readable medium may further have one or more instructions which when executed by a processor causes the processor to: (a) determine whether the integrity of the primary seed file has been compromised upon restarting the pseudorandom number generator; (b) initialize the startup internal state of the pseudorandom number generator with the initialization seed of the primary seed file if the integrity of the primary file is successfully verified; and/or (c) initialize the startup internal state of the pseudorandom number generator with the initialization seed of the shadow seed file otherwise.

### BRIEF DESCRIPTION OF THE DRAWINGS

FIG. 1 is a block diagram illustrating an example of a pseudorandom number generator in which one or more novel features described herein may implemented.

FIG. 2 is a block diagram illustrating one example of a pseudorandom number generator having initial seed management.

FIG. 3 illustrates a method for initializing a pseudorandom number generator using pre-stored seeds according to one example.

FIG. 4 is a block diagram illustrating a system that anticipates power shutoffs and stores pseudorandom output for subsequent startup initialization of a pseudorandom number generator.

FIG. 5 illustrates a method for operating a device to generate and save an initialization seed upon detection of some power off event.

FIG. 6 illustrates a method for using a primary seed file and a shadow seed file to store an initialization seed for a pseudorandom number generator.

FIG. 7 is a block diagram illustrating an example of how a time component may be utilized to counter hacking of the seed file.

FIG. 8 illustrates a method for combining time as part of an initialization seed for a pseudorandom number generator.

FIG. 9 is a block diagram illustrating a processing circuit comprising a storage medium and a processor configured to implement a pseudorandom number generator.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels, and various other mediums capable of storing, containing, or carrying instruction(s) and/or data.

Furthermore, embodiments may be implemented by hardware, software, firmware, middleware, microcode, or a combination thereof. When implemented in software, firmware, middleware, or microcode, the program code or code segments to perform the necessary tasks may be stored in a machine-readable medium such as a storage medium or other storage means. A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others.

One feature provides a secure seeding and reseeding scheme for pseudorandom number generators by using a pre-stored initialization seed. This scheme initializes a pseudorandom number generator into an unknown state even when entropy collection is unavailable.

Another aspect of the seeding scheme provides for maintaining a primary seed file and a shadow seed file with seeding information in a secure file system. If the primary seed file is corrupted, the pseudorandom number generator is seeded with the content of the shadow seed file.

Yet another feature provides the use of a trusted timer as part of the seeding mechanism as a countermeasure to hacking of the seed files. A trusted timer or clock is mixed with pre-stored seed information to add entropy even when the pre-stored seed information has been compromised.

FIG. 1 is a block diagram illustrating an example of a pseudorandom number generator in which one or more novel features described herein may implemented. Upon startup, the pseudorandom number generator 102 is configured to receive a seed from a seed generator module 104 to initialize the pseudorandom number generator 102 into an unknown state. The pseudorandom number generator 102 may be invoked by one or more applications 106, 108 and 110 to obtain a pseudorandom output of bits, symbols, and/or numbers.

Because collecting entropy with which to initialize the state of the pseudorandom number generator 102 takes time, one feature pre-stores a startup seed for this purpose. For example, the seed generator module 104 may store such startup seed so that it can be used to initialize the pseudorandom number generator into an unpredictable state even when other entropy information is unavailable. Thus, upon startup of the pseudorandom number generator 102, it can be quickly seeded by the pre-stored seed.

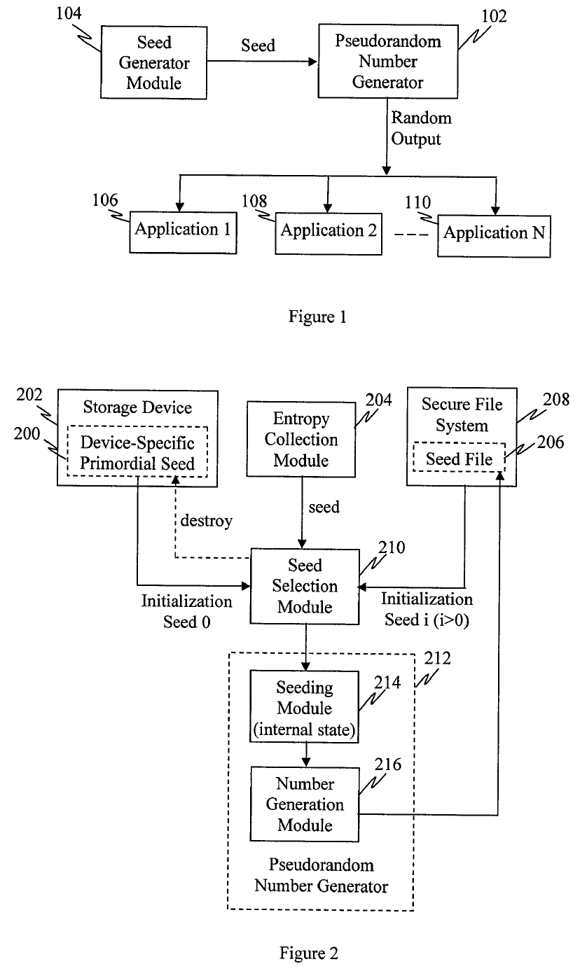

FIG. 2 is a block diagram illustrating one example of a pseudorandom number generator having initial seed management. The pseudorandom number generator may be incorporated as part of an electronic device, such as a mobile phone, computer, circuit board, chip, processor, semiconductor device, set-top box, etc., and/or a software, firmware, middleware, or microcode module. A device-specific primordial seed 200 may be stored in a storage device 202 (e.g., non-volatile memory) during manufacturing of the electronic device. In this process, the primordial seed 200 may be stored through an external interface of the storage device 202. Such primordial seed 200 may be generated offline using, for example, a different random number generator. Access to the storage device 202 where the primordial seed 200 is stored is preferably restricted so that no subsequent external read or write operation is allowed. This inhibits hackers from changing or knowing the primordial seed 200.

When the pseudorandom number generator 212 is powered up for operation for the first time, the primordial seed 200 is fed into the pseudorandom number generator 212. The entropy in the primordial seed 200 ensures that the pseudorandom number generator 212 is initialized to an unknown or unpredictable state. By doing so, the pseudorandom number generator 212 can provide pseudo-random numbers (output) for different applications immediately upon startup.

After a period of time, an entropy collection module 204 provides another seed to the pseudorandom number generator 212 with which the pseudorandom number generator 212 is reseeded. For example, a process may be initiated to request Mbytes (e.g., M=128 bytes) of random data from the pseudorandom number generator 212 and store these Mbytes into a seed file 206 in a secure file system 208. Once the seed file 206 is created, the primordial seed 200 in the storage device 202 is deleted or destroyed (e.g., reset to all zeros).

A seed selection module 210 may be coupled to the pseudorandom number generator 212 and to one or more seed sources 202, 204, and 208. For instance, the seed selection module 210 may be configured to select between the primordial seed 200 and the seed file 206 when the pseudorandom number generator is started or powered up. Additionally, the seed selection module 210 may obtain seed(s) from an entropy collection module 204 with which to periodically or sporadically reseed the pseudorandom number generator 212. The entropy collection module 204 may be configured to collect random data or information from one or more sources that may then be used to generate a seed.

When the pseudorandom number generator 212 is subsequently restarted (e.g., after power cycling), the seed selection module 210 checks the storage device 202 to determine if a valid primordial seed is available. Since the primordial seed 200 in the storage device 202 has been deleted or destroyed, the storage device 202 may contain zeros or a flag indicating that the seed file 206 is available and/or should be used. The seed selection module 210 then obtains an initialization seed from the seed file 206 and uses it to initialize the internal state of the pseudorandom number generator 212 to an unknown or unpredictable state. The secure file system 208 ensures confidentiality and integrity of the seed file 206. In one example, a secure file system may use cryptography to protect confidentiality and integrity of the seed file 206 content. In another example, the secure file system is inaccessible to the user and/or operating system of the device but is accessible by the seed selection module 210 and/or pseudorandom number generator 212.

The pseudorandom number generator 212 may include a seeding module 214 that receives seeds to initialize the internal state(s) of the pseudorandom number generator 212. A number generator module 216 then generates pseudorandom output based on the states set by the seeding module 214.

Some of the pseudorandom output from the pseudorandom number generator 212 may be stored as an initialization seed for subsequent power ups. This process of storing new random information in the seed file 206 and using it to reseed the pseudorandom number generator 212 upon startup is repeated so that different initialization seeds are used each time. In one implementation, the pseudorandom output stored in the seed file 206 (as an initialization seed) is obtained after the pseudorandom number generator 212 has been reseeded with a seed containing entropy (e.g., from the entropy collection module 204).

In an alternative implementation, the primordial seed 200 may instead be stored directly in the seed file 206 during manufacturing or other secure initialization procedure. The primordial seed may then be destroyed after the first initialization of the pseudorandom number generator 212 and random information is stored in the seed file 206 for subsequent reseeding of the pseudorandom number generator 212.

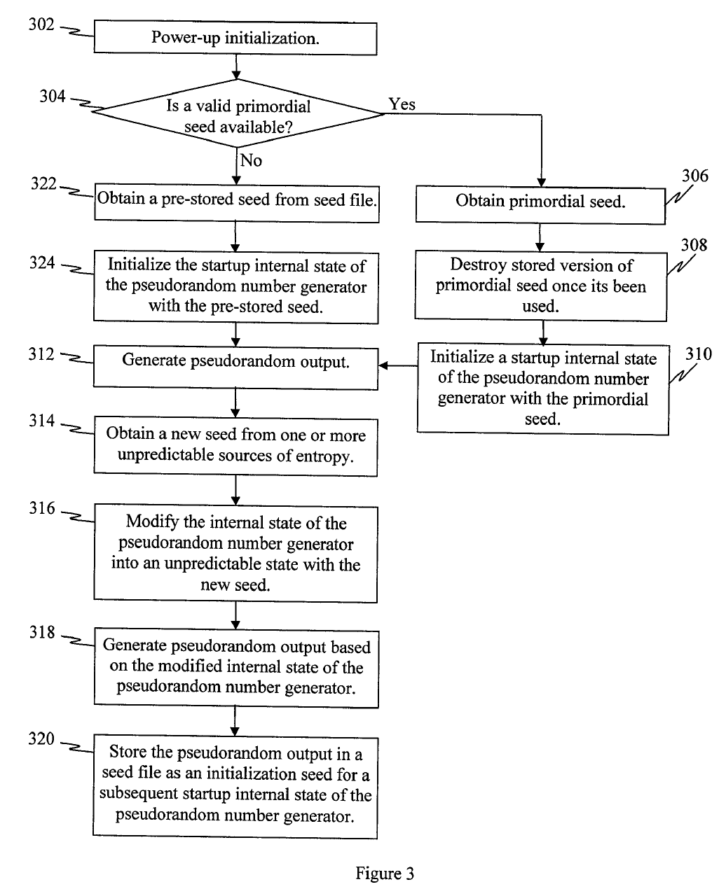

FIG. 3 illustrates a method for initializing a pseudorandom number generator using pre-stored seeds according to one example. During power-up initialization 302 of the pseudorandom number generator, a determination is made as to whether a primordial seed is available 304. The availability of a primordial seed may indicate that this is the first time that the pseudorandom number generator is being initialized. If such primordial seed is available, it is obtained 306 from a secure storage source and the stored version of the primordial seed is destroyed once it has been used 308. Destroying the stored primordial seed may serve as a future indicator that the pseudorandom number generator has been previously started. Alternatively, a flag may be set in a secure location to indicate the same. The startup internal state of the pseudorandom number generator is then initialized with the primordial seed 310 to generate a pseudorandom output 312. At this point, the pseudorandom number generator is able to provide pseudorandom output (e.g., numbers, bits, bytes, symbols, etc.) to a calling application.

One or more sources of entropy may be used to obtain a new seed 314. The internal state of the pseudorandom number generator is modified into an unpredictable state with the new seed 316. Pseudorandom output is then generated based on the modified internal state of the pseudorandom number generator 318. The pseudorandom output is stored in a seed file as an initialization seed for a subsequent startup internal state of the pseudorandom number generator 320. A startup internal state refers to the state of the pseudorandom number generator immediately after it has been powered up.

When the pseudorandom number generator is powered on subsequent times, then the primordial seed is no longer available 304. Thus, a pre-stored seed is obtained from the seed file 322 instead. The startup internal state of the pseudorandom number generator is then initialized with the pre-stored seed 324 and the pseudorandom number generator is able to generate pseudorandom output 312. This initial seeding process is repeated during subsequent startups of the pseudorandom number generator.

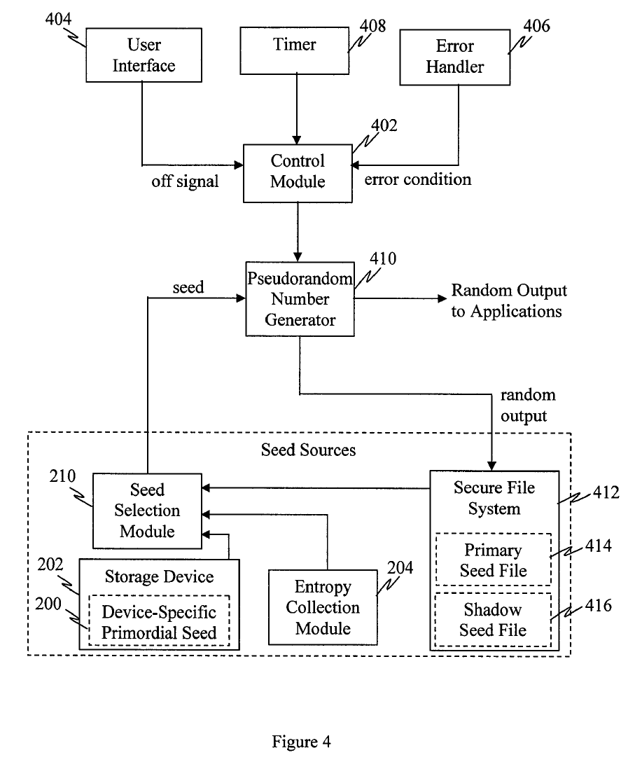

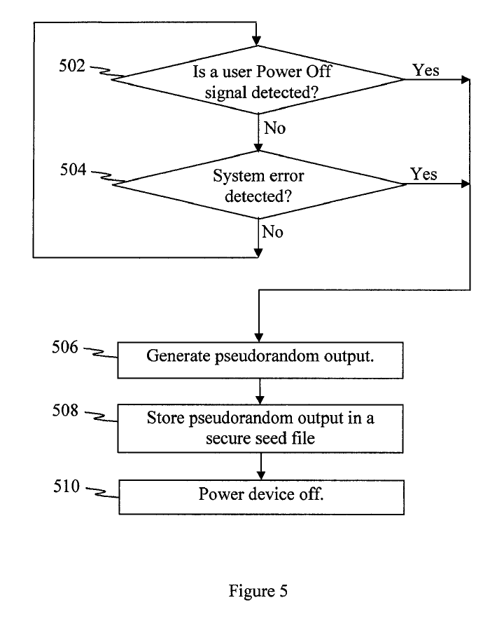

FIG. 4 is a block diagram illustrating a system that anticipates power shutoffs and stores pseudorandom output for subsequent startup initialization of a pseudorandom number generator. The pseudorandom number generator may be incorporated as part of an electronic device (e.g., chip, circuit, etc). Such device may be powered off when: (1) the user turns off the power to the device, (2) the device shuts itself down due to some error(s), and/or (3) the device crashes.

A control module 402 may collect information from various sources to determine whether the device is about to shutoff. For instance, the control module 402 may be coupled to a user interface 404 (e.g., on/off switch, etc.) to detect when a user turns the device off. Similarly, the control module 402 may be coupled to an error handler 406 that detects when an error has occurred and shuts off the device in a controlled manner. When either the user interface 404 or the error handler 406 indicates that the device is about to be turned off, the control module 402 may be configured to cause the pseudorandom number generator 410 to generate a pseudorandom output and store it in the seed file 414 in a secure file system 412.

FIG. 5 illustrates a method for operating a device to generate and save an initialization seed upon detection of some power off event. For example, if a power off signal is detected 502 or a system error is detected 504, a pseudorandom output is generated 506 and stored in a secure seed file 508 prior to powering off the device 510. The pseudorandom output stored in the secure seed file may be used on the next power up to initialize a pseudorandom number generator.

However, when a fatal error occurs (e.g., the device runs out of the power or a denial-of-service attack causes memory corruption), it may be difficult to detect the device crashing and the seed file 414 may not be successfully updated before the device shuts off. To address this problem, a timer 408 is coupled to the control module 402. The control module 402 receives a periodic signal from the timer 408 that causes the control module 402 to request that the pseudorandom number generator 410 provide a pseudorandom output to be stored in the seed file 414.

One threat to using the seed file 414 is forgery of the seed file. One countermeasure is to locate the seed file 414 in a secure file system 412 in a privileged partition. The privileged partition may reside outside a normal file system, and as such cannot be erased via system updates. The normal file access interface of the system is not aware of the existence of the secure file system 412.

Another feature provides for maintaining a primary seed file 414 and a shadow seed file 416 in the secure file system 412 (within the privileged partition). Seed information is first saved to the primary seed file 414 and then to the shadow seed file 416. In the event that a fatal error occurs while writing to the primary seed file 414, the previously unused seed information is still stored in the shadow seed file 416 and is used to initialize the pseudorandom number generator 410 on the next power up. This way there is always good seed information available during power-up to initialize the pseudorandom number generator 410.

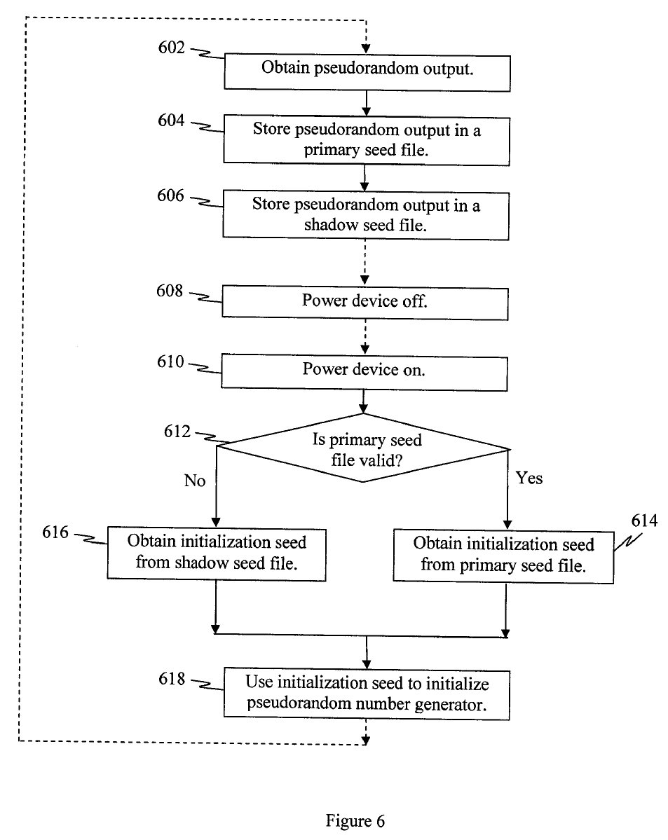

FIG. 6 illustrates a method for using a primary seed file and a shadow seed file to store an initialization seed for a pseudorandom number generator. Pseudorandom output is obtained 602 from the pseudorandom number generator. The pseudorandom output (e.g., bits, symbols, numbers, etc.) is first stored in a primary seed file 604 to be used subsequently as an initialization seed. The pseudorandom output may replace other content previously stored in the primary seed file. The same pseudorandom output is then stored in a shadow seed file 606. Subsequently, the pseudorandom number generator may be powered off 608.

When the pseudorandom number generator is powered back on 610, the integrity and/or authenticity of the primary seed file may be checked to determine whether it is valid 612. If the primary seed file is valid, the initialization seed is obtained from the content of the primary seed file 614. Otherwise, if the primary seed file is not valid (e.g., the file content is corrupt), the initialization seed is obtained from the content of the shadow seed file 616. The initialization seed is used to initialize the pseudorandom number generator 618. The pseudorandom number generator may then provide pseudorandom output to calling applications. This process may be repeated every time the pseudorandom random number generator is powered off and on so that different initialization seeds are used to initialize the pseudorandom number generator.

In some implementations, it may not be possible to use a privileged partition (where the secure file system 412 is maintained). Without such privileged partition, it may be possible for a hacker to overwrite the seed file with a legal copy of a previous seed file that was backed up. Then, the hacker may immediately crash the device that incorporates the pseudorandom number generator (e.g., by disconnecting the power source) thereby tricking the device into using the previous seed file on the next power up cycle. Since the previous seed file is a legal copy, it would be accepted by the pseudorandom number generator during power-up stage. The pseudorandom number generator may then produce the same output sequence during power-up stage every time the hacker uses the same previous seed file until it is reseeded by the entropy collection module. Thus, the hacker may be able to control the initial output of the pseudorandom number generator.

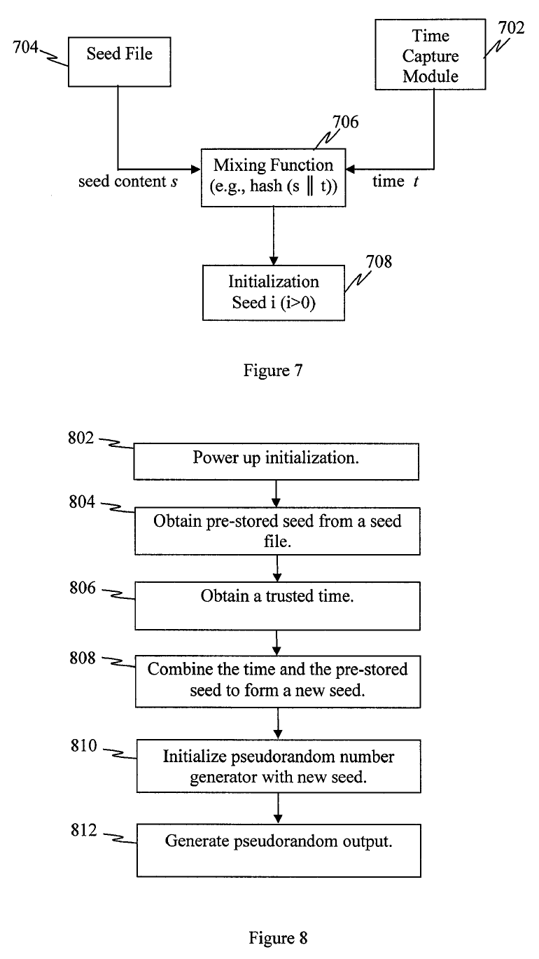

To counter such hacking, one feature provides for using time as part of a startup initialization seed to further protect the pseudorandom number generator against hacking. FIG. 7 is a block diagram illustrating an example of how a time component may be utilized to counter hacking of the seed file. A time capture module 702 is used to capture time from a trustable internal clock or some time signal from a network (e.g., CDMA network). The seed content s from the seed file 704 is mixed with the time t (from time capture module 702) to form an initial seed 708. The mixing function 706 may be selected or configured so that each bit change in time t is dissipated into the whole range of the function output. In this manner, any change in the time t would cause the whole initialization seed 708 to change. One example of the mixing function 706 is a hash algorithm (e.g., init_seed=hash (s∥t), where “∥” denotes concatenation). As a result, even if the same seed file is reused, a new time t′ makes the initial seed hash(s∥t′) different from hash(s∥t). The initial seed 708 may then be used to initialize the pseudorandom number generator.

FIG. 8 illustrates a method for combining time as part of an initialization seed for a pseudorandom number generator. Upon powering up of the pseudorandom number generator 802, a pre-stored seed is obtained from a seed file 804. A trusted time is obtained 806 (from a secure source) and combined with the pre-stored seed to form a new initialization seed 808. The new seed is used to initialize a pseudorandom number generator 810 and generate pseudorandom output 812.

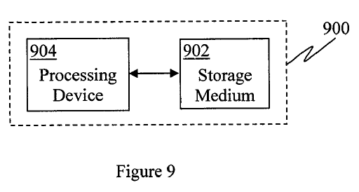

FIG. 9 is a block diagram illustrating a processing circuit 900 comprising a storage medium 902 and a processor 904 configured to implement a pseudorandom number generator. The storage medium 902 may be a memory device and/or hard drive, for example, that includes one or more internal state registers to store the internal state of a pseudorandom number generator. The processing device 904 may be configured to initialize a startup internal state of the pseudorandom number generator with a pre-stored primordial seed. The stored primordial seed may be destroyed after it has been used once. A new seed may be obtained from one or more unpredictable sources of entropy. The pseudorandom number generator is initialized with the new seed to modify the internal state of the pseudorandom number generator into an unpredictable state. A pseudorandom output is generated based on the modified internal state of the pseudorandom number generator. The pseudorandom output is stored in a seed file as an initialization seed for a subsequent startup internal state of the pseudorandom number generator.

In one implementation, the processing device may be further configured to (1) retrieve the initialization seed from the seed file after the pseudorandom number generator is restarted, (2) obtain a time value from a trusted source, (3) combine the time value and initialization seed to obtain a modified initialization seed, (4) initialize a startup internal state of the pseudorandom number generator with the modified initialization seed, and/or (5) replace the content of the seed file with a new initialization seed obtained from pseudorandom output of the pseudorandom number generator. The time value and initialization seed may be combined such that the time value is dissipated into the whole range of the modified initialization seed.

The processing device may be further configured to (1) store the pseudorandom output in a primary seed file and a shadow file in a secure file system, (2) determine whether the integrity of the primary seed file has been compromised upon restarting the pseudorandom number generator, (3) initialize the startup internal state of the pseudorandom number generator with the initialization seed of the primary seed file if the integrity of the primary file is successfully verified, and/or (4) initialize the startup internal state of the pseudorandom number generator with the initialization seed of the shadow seed file otherwise.

In another example, the storage medium 902 may be a machine-readable medium that stores instructions which, when executed by the processor 904 may cause the processor 904 to (1) initialize a startup internal state of the pseudorandom number generator with a pre-stored primordial seed, (2) destroy the stored primordial seed after it has been used once, (3) obtain a new seed from one or more unpredictable sources of entropy, (4) reseed the pseudorandom number generator with the new seed to modify the internal state of the pseudorandom number generator into an unpredictable state, (5) generate a pseudorandom output based on the modified internal state of the pseudorandom number generator, and/or (6) store the pseudorandom output in a seed file as an initialization seed for a subsequent startup internal state of the pseudorandom number generator. The machine-readable medium (storage medium 902) may further have one or more instructions which when executed by the processor 904 causes the processor to: (1) retrieve the initialization seed from the seed file after the pseudorandom number generator is restarted, (2) obtain a time value from a trusted source, (3) combine the time value and initialization seed to obtain a modified initialization seed, (4) initialize a startup internal state of the pseudorandom number generator with the modified initialization seed, and/or (5) replace the content of the seed file with a new initialization seed obtained from pseudorandom output of the pseudorandom number generator.

According to another feature, the seed file may include a primary seed file and a shadow seed file in a secure file system. The machine-readable medium (storage device 902) may further have one or more instructions which when executed by a processor causes the processor to: (1) determine whether the integrity of the primary seed file has been compromised upon restarting the pseudorandom number generator, (2) initialize the startup internal state of the pseudorandom number generator with the initialization seed of the primary seed file if the integrity of the primary file is successfully verified, and/or (3) initialize the startup internal state of the pseudorandom number generator with the initialization seed of the shadow seed file otherwise.

Accordingly a pseudorandom number generator is provided, comprising: (1) means for initializing a startup internal state of the pseudorandom number generator with a pre-stored primordial seed, (2) means for destroying the stored primordial seed after it has been used once, (3) means for obtaining a new seed from one or more unpredictable sources of entropy, (4) means for modifying the internal state of the pseudorandom number generator into an unpredictable state with the new seed, (5) means for generating a pseudorandom output based on the modified internal state of the pseudorandom number generator, and/or (6) means for storing the pseudorandom output in a seed file as an initialization seed for a subsequent startup internal state of the pseudorandom number generator. The pseudorandom number generator may further comprise: (7) means for storing the primordial seed in a secure location during manufacturing of the pseudorandom number generator, (8) means for retrieving the initialization seed from the seed file after the pseudorandom number generator is restarted, (9) means for initializing the startup internal state of the pseudorandom number generator with the initialization seed, and/or (10) means for replacing the content of the seed file with a new initialization seed obtained from the pseudorandom number generator.

One or more of the components, steps, and/or functions illustrated in FIGS. 1, 2, 3, 4, 5, 6, 7, 8 and/or 9 may be rearranged and/or combined into a single component, step, or function or embodied in several components, steps, or functions without affecting the operation of the pseudo-random number generation. Additional elements, components, steps, and/or functions may also be added without departing from the invention. The apparatus, devices, and/or components illustrated in FIGS. 1, 2, 4, 7 and/or 9 may be configured to perform one or more of the methods, features, or steps described in FIGS. 3, 5, 6, and/or 8. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method for operating a pseudorandom number generator, comprising:
initializing a startup internal state of the pseudorandom number generator with a pre-stored primordial seed;
destroying the stored primordial seed after it has been used once;
obtaining a new seed from one or more unpredictable sources of entropy;
modifying the internal state of the pseudorandom number generator into an unpredictable state with the new seed;
generating a pseudorandom output based on the modified internal state of the pseudorandom number generator; and
storing the pseudorandom output in a seed file as an initialization seed for a subsequent startup internal state of the pseudorandom number generator.

2. The method of claim 1 further comprising:
storing the primordial seed in a secure location during manufacturing of the pseudorandom number generator.

3. The method of claim 2 wherein reseeding of the pseudorandom number generator is periodically performed according to an interval timer.

4. The method of claim 1 further comprising:
retrieving the initialization seed from the seed file after the pseudorandom number generator is restarted;
initializing the startup internal state of the pseudorandom number generator with the initialization seed; and
replacing the content of the seed file with a new initialization seed obtained from the pseudorandom number generator.

5. The method of claim 1 further comprising:
retrieving the initialization seed from the seed file after the pseudorandom number generator is restarted;
obtaining a time value from a trusted source;
combining the time value and initialization seed to obtain a modified initialization seed;
initializing a startup internal state of the pseudorandom number generator with the modified initialization seed; and
replacing the content of the seed file with a new initialization seed obtained from pseudorandom output of the pseudorandom number generator.

6. The method of claim 5 wherein the time value and initialization seed are combined such that the time value is dissipated into the whole range of the modified initialization seed.

7. The method of claim 1 wherein storing the pseudorandom output in a seed file includes
storing the pseudorandom output in a primary seed file in a secure file system; and
storing the pseudorandom output in a shadow seed file in the secure file system.

8. The method of claim 7 further comprising:
determining whether the integrity of the primary seed file has been compromised upon restarting the pseudorandom number generator;
initializing the startup internal state of the pseudorandom number generator with the initialization seed of the primary seed file if the integrity of the primary file is successfully verified; and
initializing the startup internal state of the pseudorandom number generator with the initialization seed of the shadow seed file otherwise.

9. A pseudorandom number generator, comprising:
means for initializing a startup internal state of the pseudorandom number generator with a pre-stored primordial seed;
means for destroying the stored primordial seed after it has been used once;
means for obtaining a new seed from one or more unpredictable sources of entropy;
means for modifying the internal state of the pseudorandom number generator into an unpredictable state with the new seed;
means for generating a pseudorandom output based on the modified internal state of the pseudorandom number generator; and
means for storing the pseudorandom output in a seed file as an initialization seed for a subsequent startup internal state of the pseudorandom number generator.

10. The pseudorandom number generator of claim 9 further comprising:
means for storing the primordial seed in a secure location during manufacturing of the pseudorandom number generator.

11. The pseudorandom number generator of claim 9 further comprising:
means for retrieving the initialization seed from the seed file after the pseudorandom number generator is restarted;
means for initializing the startup internal state of the pseudorandom number generator with the initialization seed; and
means for replacing the content of the seed file with a new initialization seed obtained from the pseudorandom number generator.

12. The pseudorandom number generator of claim 9 further comprising:
means for retrieving the initialization seed from the seed file after the pseudorandom number generator is restarted;
means for obtaining a time value from a trusted source;
means for combining the time value and initialization seed to obtain a modified initialization seed;
means for initializing a startup internal state of the pseudorandom number generator with the modified initialization seed; and
means for replacing the content of the seed file with a new initialization seed obtained from pseudorandom output of the pseudorandom number generator.

13. The pseudorandom number generator of claim 12 wherein the time value and initialization seed are combined such that the time value is dissipated into the whole range of the modified initialization seed.

14. The pseudorandom number generator of claim 9 wherein storing the pseudorandom output in a seed file includes
means for storing the pseudorandom output in a primary seed file in a secure file system; and
means for storing the pseudorandom output in a shadow seed file in the secure file system.

15. The pseudorandom number generator of claim 14 further comprising:
means for determining whether the integrity of the primary seed file has been compromised upon restarting the pseudorandom number generator;
means for initializing the startup internal state of the pseudorandom number generator with the initialization seed of the primary seed file if the integrity of the primary file is successfully verified; and
means for initializing the startup internal state of the pseudorandom number generator with the initialization seed of the shadow seed file otherwise.

16. A pseudorandom number generator comprising:
a seed selection module configured to select a seed from one or more seed sources;
a seeding module coupled to the seed selection module and configured to adjust an internal state of the pseudorandom number generator according to a seed provided by the seed selection module; and
a number generation module coupled to the seeding module and configured to generate a pseudorandom output based on the internal state of the pseudorandom number generator;
wherein the seed selection module is further configured to
select a pre-stored primordial seed to initialize a startup internal state of the pseudorandom number generator if it is the first time the pseudorandom number generator is started; and
select an initialization seed from a pre-stored seed file to initialize the startup internal state the pseudorandom number generator if the pseudorandom number generator has been previously started.

17. The pseudorandom number generator of claim 16 wherein the seed selection module is further configured to destroy the stored primordial seed after it has been used once.

18. The pseudorandom number generator of claim 16 wherein the number generation module provides a pseudorandom output that is stored in the seed file and used as the initialization seed.

19. The pseudorandom number generator of claim 16 further comprising:
a trusted time source coupled to the seeding module, wherein the seeding module is further configured to
obtain a time value from the trusted time source;
combine the time value and initialization seed to obtain a modified initialization seed; and
initialize a startup internal state of the pseudorandom number generator with the modified initialization seed.

20. The pseudorandom number generator of claim 19 wherein the time value and initialization seed are combined such that the time value is dissipated into the whole range of the modified initialization seed.

21. The pseudorandom number generator of claim 16 further comprising:
a secure file system for storing the seed file, wherein the seed file includes a primary seed file and a shadow seed file; and
wherein the seed selection module is further configured to
determine whether the integrity of the primary seed file has been compromised upon restarting the pseudorandom number generator;
initialize the startup internal state of the pseudorandom number generator with the initialization seed of the primary seed file if the integrity of the primary file is successfully verified; and
initialize the startup internal state of the pseudorandom number generator with the initialization seed of the shadow seed file otherwise.

22. A processing circuit comprising
a memory device including one or more internal state registers to store the internal state of a pseudorandom number generator; and
a processing device coupled to the memory device and configured to
initialize a startup internal state of the pseudorandom number generator with a pre-stored primordial seed;
destroy the stored primordial seed after it has been used once;
obtain a new seed from one or more unpredictable sources of entropy;
reseed the pseudorandom number generator with the new seed to modify the internal state of the pseudorandom number generator into an unpredictable state;
generate a pseudorandom output based on the modified internal state of the pseudorandom number generator; and
store the pseudorandom output in a seed file as an initialization seed for a subsequent startup internal state of the pseudorandom number generator.

23. The processing circuit of claim 22 wherein the processing device is further configured to retrieve the initialization seed from the seed file after the pseudorandom number generator is restarted;
obtain a time value from a trusted source;
combine the time value and initialization seed to obtain a modified initialization seed;
initialize a startup internal state of the pseudorandom number generator with the modified initialization seed; and
replace the content of the seed file with a new initialization seed obtained from pseudorandom output of the pseudorandom number generator.

24. The processing circuit of claim 23 wherein the time value and initialization seed are combined such that the time value is dissipated into the whole range of the modified initialization seed.

25. The processing circuit of claim 22 wherein the processing device is further configured to
store the pseudorandom output in a primary seed file in a secure file system; and
store the pseudorandom output in a shadow seed file in the secure file system.

26. The processing circuit of claim 25 wherein the processing device is further configured to
determine whether the integrity of the primary seed file has been compromised upon restarting the pseudorandom number generator;
initialize the startup internal state of the pseudorandom number generator with the initialization seed of the primary seed file if the integrity of the primary file is successfully verified; and
initialize the startup internal state of the pseudorandom number generator with the initialization seed of the shadow seed file otherwise.

27. A machine-readable medium having one or more instructions for generating pseudorandom output, which when executed by a processor causes the processor to:
initialize a startup internal state of the pseudorandom number generator with a pre-stored primordial seed;
destroy the stored primordial seed after it has been used once;
obtain a new seed from one or more unpredictable sources of entropy;
reseed the pseudorandom number generator with the new seed to modify the internal state of the pseudorandom number generator into an unpredictable state;
generate a pseudorandom output based on the modified internal state of the pseudorandom number generator; and
store the pseudorandom output in a seed file as an initialization seed for a subsequent startup internal state of the pseudorandom number generator.

28. The machine-readable medium of claim 27 further having one or more instructions which when executed by a processor causes the processor to:
retrieve the initialization seed from the seed file after the pseudorandom number generator is restarted;
obtain a time value from a trusted source;
combine the time value and initialization seed to obtain a modified initialization seed;
initialize a startup internal state of the pseudorandom number generator with the modified initialization seed; and
replace the content of the seed file with a new initialization seed obtained from pseudorandom output of the pseudorandom number generator.

29. The machine-readable medium of claim 28 wherein the time value and initialization seed are combined such that the time value is dissipated into the whole range of the modified initialization seed.

30. The machine-readable medium of claim 27 wherein the seed file includes
a primary seed file and a shadow seed file in a secure file system;
and further having one or more instructions which when executed by a processor causes the processor to:
determine whether the integrity of the primary seed file has been compromised upon restarting the pseudorandom number generator;
initialize the startup internal state of the pseudorandom number generator with the initialization seed of the primary seed file if the integrity of the primary file is successfully verified; and
initialize the startup internal state of the pseudorandom number generator with the initialization seed of the shadow seed file otherwise.
